(19) United States
(12) Patent Application Publication
(10) Pub. No.: US 2023/0230280 A1
(43) Pub. Date: Jul. 20, 2023

(54) IMAGING PLATFORM WITH OUTPUT CONTROLS

(71) Applicant: Creative Technology Ltd, Singapore (SG)

(72) Inventors: Wong Hoo SIM, Singapore (SG); Aik Hee GOH, Singapore (SG); Kee Seng TAN, Singapore (SG); Wei-Peng Renny LIM, Singapore (SG); Chin Fang LIM, Singapore (SG)

(73) Assignee: Creative Technology Ltd, Singapore (SG)

(21) Appl. No.: 18/092,186

(22) Filed: Dec. 30, 2022

Related U.S. Application Data
(60) Provisional application No. 63/295,599, filed on Dec. 31, 2021.

(51) Int. Cl. G06T 7/80; G06T 7/00

(52) U.S. Cl. CPC G06T 7/80; G06T 7/97; G02B 7/09

(57) ABSTRACT

An imaging platform for capturing multiple views is provided. The imaging platform includes a desktop base, an upright element having a first end and a second end, the first end coupled to the desktop base, a first camera and a second camera positioned on at least one protruding element coupled to the upright element, the second camera facing the desktop base, a control panel for selecting a selection of a plurality of different outputs, and a processor. The processor obtains at least one camera output from the first camera and/or the second camera based on the selection of the plurality of outputs on the control panel, and provides a processed output based on the selection of the plurality of outputs on the control panel.

### CROSS-REFERENCE TO RELATED APPLICATIONS

This application claims the benefit of U.S. Provisional Application No. 63/295,599, filed 31 Dec. 2021 and entitled “IMAGING PLATFORM WITH OUTPUT CONTROLS”, the disclosure of which is herein incorporated by reference in its entirety.

### TECHNICAL FIELD

The present invention generally relates to an imaging platform, and more particularly relates to an imaging platform with output controls.

### BACKGROUND

Virtual meetings or lessons are conducted online, commonly with the usage of an image capturing apparatus which captures and sends images to the participant(s) of the virtual meeting or lesson. The need for people to register facial expression in communication in widely known, and non-verbal cues are important to provide context to spoken word communication. Hand written content can also be more effective than pre-prepared slides and other visual content as it allows the presenter to pace the content delivery at a speed that is more easily absorbed by the audience. However, typical image capturing apparatus does not provide a combined facial and tabletop camera that allows the educators and students to capture both facial expression and presentation/teaching material (including written content) in a single view.

Thus, it can be seen that what is needed is an imaging platform with output controls for capturing and providing both facial expression and presentation/teaching material in a single output that is able to enhance the user’s experience of conducting or attending virtual meetings or lessons. Furthermore, other desirable features and characteristics will become apparent from the subsequent detailed description and the appended claims, taken in conjunction with the accompanying drawings and this background of the disclosure.

### SUMMARY

In one aspect of the invention, an imaging platform for capturing multiple views is provided. The imaging platform includes a desktop base, an upright element having a first end and a second end, the first end coupled to the desktop base, a first camera and a second camera positioned on at least one protruding element coupled the upright element, the second camera facing the desktop base, a control panel for selecting a selection of a plurality of different outputs, and a processor. The processor obtains at least one camera output from the first camera and/or the second camera based on the selection of the plurality of outputs on the control panel, and provides a processed output based on the selection of the plurality of outputs on the control panel.

### BRIEF DESCRIPTION OF THE DRAWINGS

FIG. 1A shows a top front right perspective view of an imaging platform in accordance with various embodiments.

FIG. 1B shows a top front right perspective view of an imaging platform in accordance with various embodiments.

FIG. 1C shows a top front right perspective view of an imaging platform in accordance with various embodiments.

FIG. 2A shows a top planar view of an imaging platform in accordance with various embodiments.

FIG. 2B shows a top planar view of an imaging platform in accordance with various embodiments.

FIG. 2C shows a top planar view of an imaging platform in accordance with various embodiments.

FIG. 3A shows a right side planar view of an imaging platform in accordance with various embodiments.

FIG. 3B shows a right side planar view of an imaging platform in accordance with various embodiments.

FIG. 3C shows a right side planar view of an imaging platform in accordance with various embodiments.

FIG. 4A shows a front planar view of an imaging platform in accordance with various embodiments.

FIG. 4B shows a front planar view of an imaging platform in accordance with various embodiments.

FIG. 4C shows a front planar view of an imaging platform in accordance with various embodiments.

FIG. 5 shows a top front right perspective view of an imaging platform in accordance with various embodiments.

FIG. 6A shows a top front right perspective view of an imaging platform in accordance with various embodiments.

FIG. 6B shows a top front right perspective view of an imaging platform in accordance with various embodiments.

FIG. 7 shows a top back left perspective view rotated 90 degrees clockwise of an imaging platform in accordance with various embodiments.

FIG. 8 shows a front planar view rotated 90 degrees clockwise of an imaging platform in accordance with various embodiments.

FIG. 9A shows a selection of a plurality of different outputs of an imaging platform in accordance with various embodiments.

FIG. 9B shows a selection of a plurality of different outputs of an imaging platform in accordance with various embodiments.

FIG. 10 shows a selection of a plurality of different outputs of an imaging platform in accordance with various embodiments.

FIG. 11A shows an output of an imaging platform in accordance with various embodiments.

FIG. 11B shows an output of an imaging platform in accordance with various embodiments.

### DETAILED DESCRIPTION OF PREFERRED EMBODIMENTS

The following detailed description is merely exemplary in nature and is not intended to limit the invention or the application and uses of the invention. Furthermore, there is no intention to be bound by any theory presented in the preceding background of the invention or the following detailed description. It is an intent of the various embodiments to present an imaging platform with output controls for capturing and providing both facial expression and presentation/teaching material in a single output that is able to enhance the user’s experience of conducting virtual meetings or lessons.

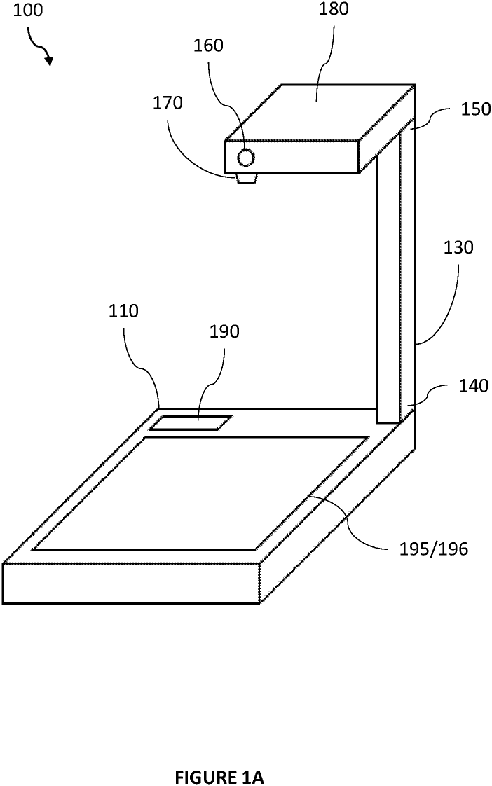

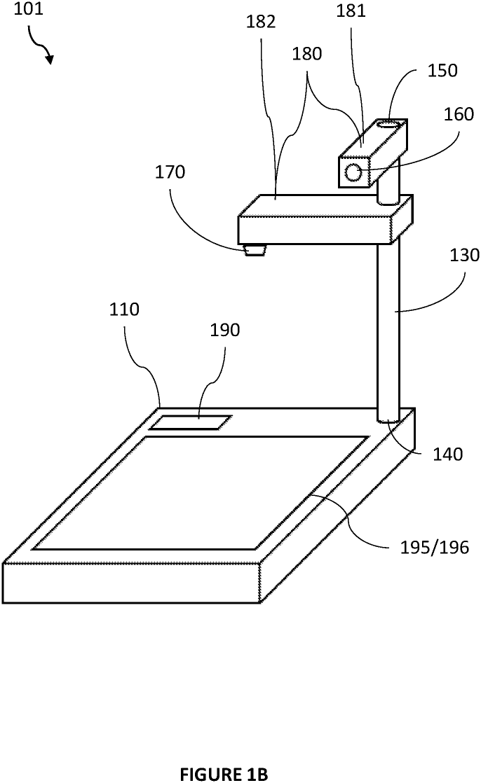

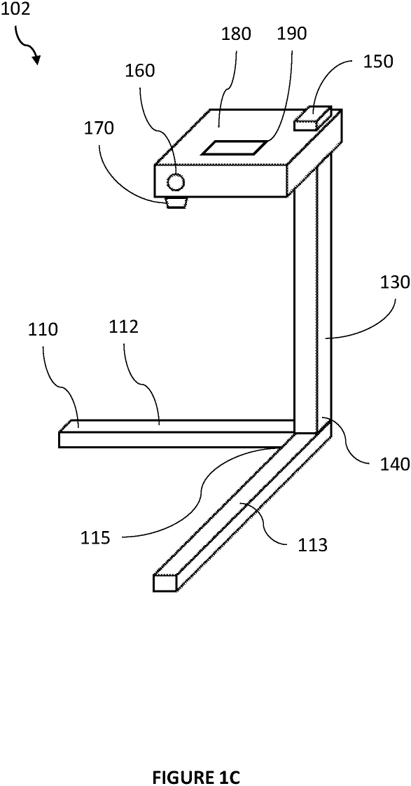

Referring to FIG. 1A, a top front right perspective view of an imaging platform 100 in accordance with various embodiments is shown. In one embodiment, the imaging platform 100 has a desktop base 110 which lies flat on a supporting structure such as a table top (not shown). As shown in FIG. 1A, the desktop base 110 is in a horizontal orientation. An upright element 130 having a first end 140 and a second end 150 is coupled to the desktop base 110 at the first end 140. The second end 150 of the upright element 130 is coupled to at least one protruding element 180. The at least one protruding element 180 has a first camera 160 and a second camera 170 positioned thereon. The first camera 160 faces forward and may be pivotable around the horizontal axis, and/or the vertical axis. Pivoting the first camera 160 around the horizontal axis allows the first camera 160 to be tilted upwards or downwards, whereas pivoting around the vertical axis allows the first camera 160 to be turned to the left or right. The pivoting can be achieved by having the first camera 160 attached to a mechanical structure (e.g. ball-mount, swivel-mount, etc.) on the at least one protruding element 180. Advantageously, pivoting the first camera 160 around the horizontal axis and/or the vertical axis allows the first camera 160 to be adjusted towards the user so that the facial expression of the user can be captured by the first camera 160. The horizontal and/or vertical pivoting can be by manual or motorized or automatic means. Although the upright element 130 is shown to be cuboid in shape, it can also be circular in shape. Advantageously, the at least one protruding element 180 can move about and /or pivot around the upright element 130 along its vertical axis. In a preferred embodiment, the at least one protruding element 180 is positioned near the second end 150 of the upright element 130, and the upright element 130 is of sufficient height such that the at least one protruding element 180 is at or near to the user’s eye-level when the imaging platform 100 is placed on a desk.

The second camera 170 faces the desktop base 110 such that at its widest angle of view, it captures the whole surface of the desktop base 110. The desktop base 110 may be rectangular shaped, orientated in portrait or landscape configuration. Advantageously, the desktop base is of the same shape and orientation as the image sensor (not shown) within the second camera 170 as it allows for more efficient use of the camera’s image sensor to capture presentation/teaching materials that may be in different formats and layouts (including square, and rectangular that may be landscape or portrait orientated). In one example, imaging platform 100 has a display 195 positioned on the surface of the desktop base 110. Some examples of display 195 are an LCD display, or an OLED display. In one further example, a digitizer 196 may be positioned on the desktop base 110, above the display 195. The digitizer 196 can be a layer of glass designed to convert analogue touches into digital signals. Advantageously, the digitizer 196 allows the user to write or draw directly on the display by converting the pressure from the finger(s) or stylus into a digitized signal and displaying the digitized signal or a form of the digitized signal on the display 195. The second camera 170 can for example have an autofocus lens or a fixed focus lens, and/or a zoom lens (variable focal length) or a prime lens (fixed focal length). In one example, the at least one protruding element 180 is moved upwards or downwards along the upright element 130 and an autofocus lens on the second camera 170 is used advantageously to get the surface of the desktop base 110, the display 195, and/or the objects on the desktop base 110 back in focus. In another example, objects of different heights are placed on the desktop base 110 and an autofocus lens on the second camera 170 is used advantageously to get the surface of the desktop base 110, the display 195 and/or the correct portions of the objects on the desktop base 110 in focus. Advantageously, the range of movement of the at least one protruding element 180 can be limited to the depth of field of the second camera 170, in which case an autofocus lens may not be needed. Zoom lens can be used for the second camera 170 to provide a closer or wider look of the surface of the desktop base 110 and/or the objects on the desktop base 110. Digital zoom techniques (achieved by cropping) can also be used. Alternatively, or in combination, a closer or wider look of the surface of the desktop base 110, the display 195, and/or the objects on the desktop base 110 can also be obtained by moving the at least one protruding element 180 upwards or downwards along the upright element 130, or having a telescopic upright element 130 which can extend and retract upwards and downwards. Advantageously, the second camera 170 can be used to capture a wide variety of objects and filling the screen with the scene/object of interest, from a watch maker working on a watch movement (small), to physically large documents like an artist’s artwork on larger canvases, and a chemistry teacher’s test tube experiments.

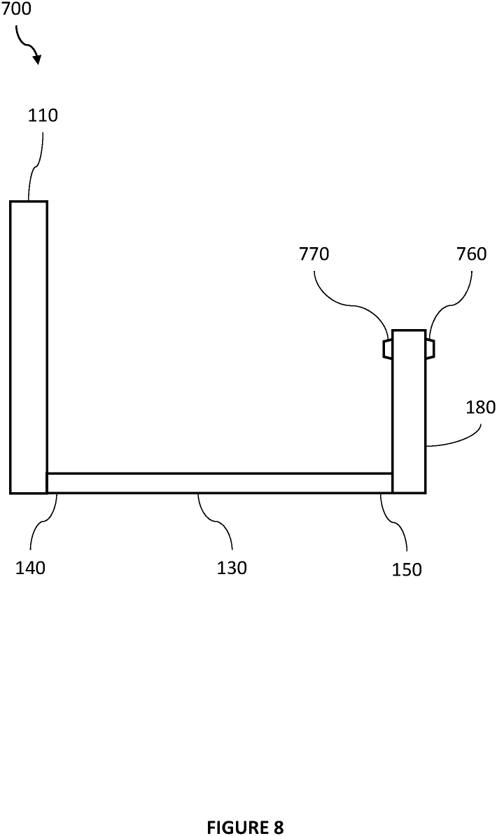

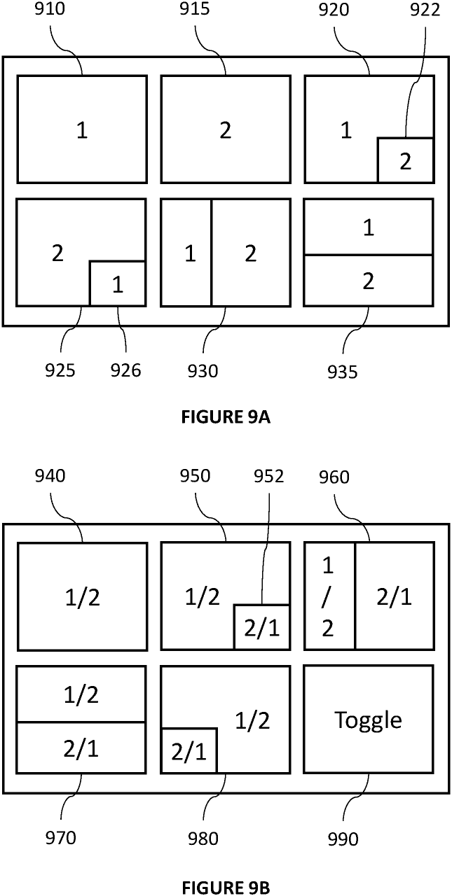

A control panel 190 for selecting from a selection of a plurality of different outputs is included in the imaging platform 100. Although the control panel 190 is shown located in an upper portion of the desktop base 110, it can be located anywhere on the imaging platform that is easily accessible by the user, and preferably located such that the user is able to access it without obstructing the view of the first camera 160 and the second camera 170. For example, the control panel 190 can be located on the at least one protruding element 180. The control panel 190 can also be coupled to the imaging platform 100 via wired cable or wirelessly. The control panel 190 has a selection of a plurality of different outputs, which the user can select using, for example, buttons, switches, knobs and the like. In one example, the selection of a plurality of outputs of the control panel 190 can also be displayed on the display 195 and selection can be made via the digitizer 196. An example of the selection that can be displayed is shown in FIGS. 9A/9B/10.

A processor (not shown) located within the imaging platform 100 obtains at least one camera output from the first camera 160 and/or the second camera 170 based on the selection of the plurality of outputs on the control panel 190, and provides a processed output based on the selection of the plurality of outputs on the control panel 190. The processed output can be provided through an output port, such as but not limited to a USB port. The processed output can be a USB Video Device Class (UVC) stream.

Referring to FIG. 1B, a top front right perspective view of an imaging platform 101 in accordance with various embodiments is shown. In one embodiment, the imaging platform 101 has a desktop base 110 which lies flat on a supporting surface such as a table top (not shown). As shown in FIG. 1B, the desktop base 110 is in a horizontal orientation. An upright element 130 having a first end 140 and a second end 150 is coupled to the desktop base 110 at the first end 140. The second end 150 of the upright element 130 is coupled to at least one protruding element 180. The protruding elements (181, 182) has a first camera 160 and a second camera 170 positioned thereon. As shown in FIG. 1B, the first camera 160 is positioned on a first protruding element 181 of the at least one protruding element 180, and the second camera 170 is positioned on a second protruding element 182 of the at least one protruding element 180.

The first camera 160 faces forward and may be pivotable around the horizontal axis, and/or the vertical axis. Pivoting the first camera 160 around the horizontal axis allows the first camera 160 to be tilted upwards or downwards, whereas pivoting around the vertical axis allows the first camera 160 to be turned to the left or right. The pivoting can be achieved by having the first camera 160 attached to a mechanical structure (e.g. ball-mount, swivel-mount, etc.) on the first protruding element 181. The pivoting may also be achieved by rotating the first protruding element 181 around the vertical-axis of the upright element 130. In a preferred embodiment, the first protruding element 181 is positioned near the second end 150 of the upright element 130, and the upright element 130 is of sufficient height such that the first protruding element 181 is at or near to the user’s eye-level when the imaging platform 101 is placed on a desk. Advantageously, pivoting the first camera 160 around the horizontal axis and/or the vertical axis allows the first camera 160 to be adjusted towards the user so that the facial expression of the user can be captured by the first camera 160. The horizontal and/or vertical pivoting can be by manual or motorized or automatic means. Although the upright element 130 is shown to be circular in shape, it can also be cuboid in shape. Advantageously, a circular upright element 130 allows the first protruding element 181 to pivot around the upright element 130, along the vertical axis without a more complicated mechanical structure attached to the camera.

The second camera 170 faces the desktop base 110 such that at its widest angle of view, it captures the whole surface of the desktop base 110. The desktop base 110 may be rectangular shaped, orientated in portrait or landscape configuration. Advantageously, the desktop base is of the same shape and orientation as the image sensor (not shown) within the second camera 170 as it allows for more efficient use of the camera’s image sensor to capture presentation/teaching materials that may be in different formats and layouts (including square, and rectangular that may be landscape or portrait orientated). In one example, imaging platform 101 has a display 195 positioned on the surface of the desktop base 110. Some examples of display 195 are an LCD display, or an OLED display. In one further example, a digitizer 196 may be positioned on the desktop base 110, above the display 195. The digitizer 196 can be a layer of glass designed to convert analogue touches into digital signals. Advantageously, the digitizer 196 allows the user to write or draw directly on the display by converting the pressure from the finger(s) or stylus into a digitized signal and displaying the digitized signal or a form of the digitized signal on the display 195. The second camera 170 can for example have an autofocus lens or a fixed focus lens, and/or a zoom lens (variable focal length) or a prime lens (fixed focal length). In one example, the second protruding element 182 is moved upwards or downwards along the upright element 130 and an autofocus lens on the second camera 170 is used advantageously to get the surface of the desktop base 110, the display 195, and/or the objects on the desktop base 110 back in focus. In another example, objects of different heights are placed on the desktop base 110 and an autofocus lens on the second camera 170 is used advantageously to get the surface of the desktop base 110, the display 195 and/or the correct portions of the objects on the desktop base 110 in focus. Advantageously, the range of movement of the second protruding element 182 can be limited to the depth of field of the second camera 170, in which case an autofocus lens may not be needed. Zoom lens can be used for the second camera 170 to provide a closer or wider look of the surface of the desktop base 110 and/or the objects on the desktop base 110. Digital zoom techniques (achieved by cropping) can also be used. Alternatively, or in combination, a closer or wider look of the surface of the desktop base 110, the display 195, and/or the objects on the desktop base 110 can also be obtained by moving the second protruding element 182 upwards or downwards along the upright element 130, or having a telescopic upright element 130 which can extend and retract upwards and downwards. Advantageously, the second camera 170 can be used to capture a wide variety of objects and filling the screen with the scene/object of interest, from a watch maker working on a watch movement (small), to physically large documents like an artist’s artwork on larger canvases, and a chemistry teacher’s test tube experiments. Although protruding element 182 is shown positioned at right angle to protruding element 181, it can be pivoted around upright element 130 such that the second camera 170 below the protruding element 182 is located substantially above the centre of the desktop base 110, such that at its widest angle of view it captures the whole surface of the desktop base 110. A mechanical structure within the protruding element 182 can maintain the orientation of the second camera’s 170 image sensor (not shown) with respect to the desktop base 110.

A control panel 190 for selecting from a selection of a plurality of different outputs is included in the imaging platform 101. Although the control panel 190 is shown located in an upper portion of the desktop base 110, it can be located anywhere on the imaging platform that is easily accessible by the user, and preferably located such that the user is able to access it without obstructing the view of the first camera 160 and the second camera 170. For example, the control panel 190 can be located on at least one protruding element 180; either the first protruding element 181 or the second protruding element 182. The control panel 190 can also be coupled to the imaging platform 101 via wired cable or wirelessly. The control panel 190 has a selection of a plurality of different outputs, which the user can select using, for example, buttons, switches, knobs and the like. In one example, the selection of a plurality of outputs of the control panel 190 can also be displayed on the display 195 and selection can be made via the digitizer 196. An example of the selection that can be displayed is shown in FIGS. 9A/9B/10.

A processor (not shown) located within the imaging platform 101 obtains at least one camera output from the first camera 160 and/or the second camera 170 based on the selection of the plurality of outputs on the control panel 190, and provides a processed output based on the selection of the plurality of outputs on the control panel 190. The processed output can be provided through an output port, such as but not limited to a USB port. The processed output can be a USB Video Device Class (UVC) stream.

Referring to FIG. 1C, a top front right perspective view of an imaging platform 102 in accordance with various embodiments is shown. In one embodiment, the imaging platform 102 has a desktop base 110 which lies flat on a supporting surface such as a table top (not shown). As shown in FIG. 1C, the desktop base 110 has a “L”-shaped structure in a horizontal orientation that allows the structure to lie flat on the supporting surface such as a table top (not shown). Although the desktop base 110 is shown with two extensions (112, 113) forming a support structure, the support structure could also be made up of three or more extensions. An upright element 130 having a first end 140 and a second end 150 is coupled to the desktop base 110 at the first end 140. The second end 150 of the upright element 130 is coupled to at least one protruding element 180. The at least one protruding element 180 has a first camera 160 and a second camera 170 positioned thereon. The first camera 160 faces forward and may be pivotable around the horizontal axis, and/or the vertical axis. Pivoting the first camera 160 around the horizontal axis allows the first camera 160 to be tilted upwards or downwards, whereas pivoting around the vertical axis allows the first camera 160 to be turned to the left or right. The pivoting can be achieved by having the first camera 160 attached to a mechanical structure (e.g. ball-mount, swivel-mount, etc.) on the at least one protruding element 180. Advantageously, pivoting the first camera 160 around the horizontal axis and/or the vertical axis allows the first camera 160 to be adjusted towards the user so that the facial expression of the user can be captured by the first camera 160. The horizontal and/or vertical pivoting can be by manual or motorized or automatic means. Although the upright element 130 is shown to be cuboid in shape, it can also be circular in shape. Advantageously, the at least one protruding element 180 can move about and /or pivot around the upright element 130 along its vertical axis. In a preferred embodiment, the at least one protruding element 180 is positioned near the second end 150 of the upright element 130, and the upright element 130 is of sufficient height such that the at least one protruding element 180 is at or near to the user’s eye-level when the imaging platform 102 is placed on a desk.

The second camera 170 faces the horizontal plane bounded by the extensions (112, 113) of the desktop base 110. In one example, the corner 115 indicates the widest limits of the second camera’s 170 angle of view. Advantageously, the corner 115 corresponds to a corner of the image sensor (not shown) within the second camera 170 as it allows for more efficient use of the camera’s image sensor to capture presentation/teaching materials that may be in different formats and layouts (including square, and rectangular that may be landscape or portrait orientated). The second camera 170 can for example have an autofocus lens or a fixed focus lens, and/or a zoom lens (variable focal length) or a prime lens (fixed focal length). In one example, the at least one protruding element 180 is moved upwards or downwards along the upright element 130 and an autofocus lens on the second camera 170 is used advantageously to get the objects captured by the second camera 170 back in focus. In another example, objects of different heights are placed on the horizontal plane bounded by the extensions (112, 113) of the desktop base 110 and an autofocus lens on the second camera 170 is used advantageously to get the objects in focus. Advantageously, the range of movement of the at least one protruding element 180 can be limited to the depth of field of the second camera 170, in which case an autofocus lens may not be needed. Zoom lens can be used for the second camera 170 to provide a closer or wider look of the object(s). Digital zoom techniques (achieved by cropping) can also be used. Alternatively, or in combination, a closer or wider look of the object(s) can also be obtained by moving the at least one protruding element 180 upwards or downwards along the upright element 130, or having a telescopic upright element 130 which can extend and retract upwards and downwards. Advantageously, the second camera 170 can be used to capture a wide variety of objects and filling the screen with the scene/object of interest, from a watch maker working on a watch movement (small), to physically large documents like an artist’s artwork on larger canvases, and a chemistry teacher’s test tube experiments.

A control panel 190 for selecting from a selection of a plurality of different outputs is included in the imaging platform 102. Although the control panel 190 is shown located on the at least one protruding element 180, it can be located anywhere on the imaging platform 102 that is easily accessible by the user, and preferably located such that the user is able to access it without obstructing the view of the first camera 160 and the second camera 170. For example, the control panel 190 can be located on one of the extensions (112, 113) of the desktop base 110. The control panel 190 can also be coupled to the imaging platform 102 via wired cable or wirelessly. The control panel 190 has a selection of a plurality of different outputs, which the user can select using, for example, buttons, switches, knobs and the like. An example of the selection that can be displayed is shown in FIGS. 9A/9B/10.

A processor (not shown) located within the imaging platform 102 obtains at least one camera output from the first camera 160 and/or the second camera 170 based on the selection of the plurality of outputs on the control panel 190, and provides a processed output based on the selection of the plurality of outputs on the control panel 190. The processed output can be provided through an output port, such as but not limited to a USB port. The processed output can be a USB Video Device Class (UVC) stream.

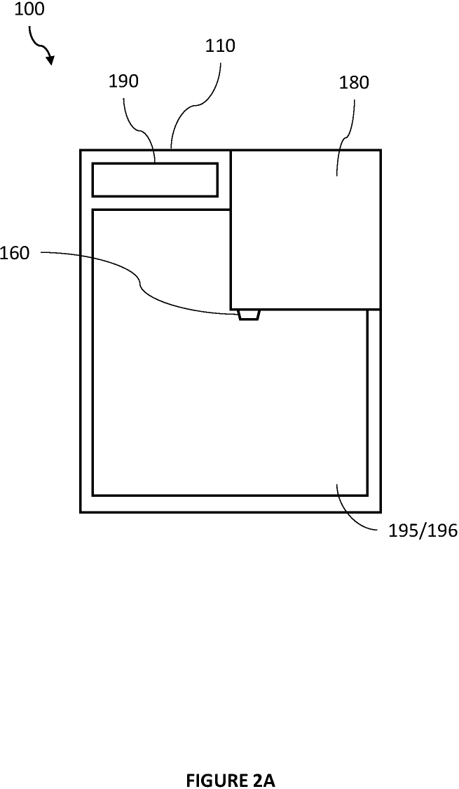

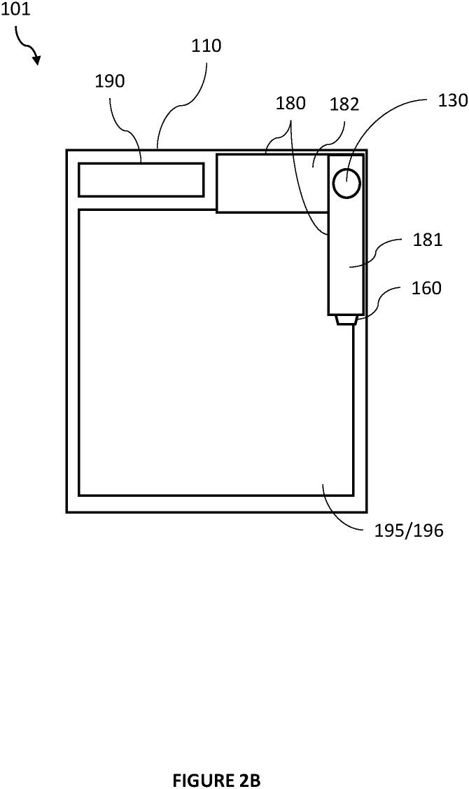

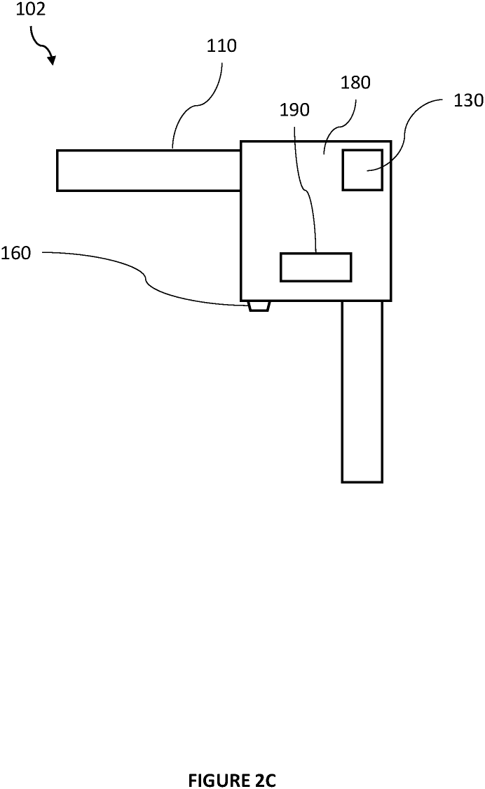

Referring to FIG. 2A, a top planar view of an imaging platform 100 in accordance with various embodiments is shown. As best seen in FIG. 2A, the first camera 160 is positioned on the at least one protruding element 180 such that it faces towards the front of the imaging platform 100, where the user is expected to be located. This allows the first camera 160 to capture the facial expressions of the user.

Referring to FIG. 2B, a top planar view of an imaging platform 101 in accordance with various embodiments is shown. As best seen in FIG. 2B, the first camera 160 is positioned on a first protruding element 181 of the at least one protruding element 180 such that it faces towards the front of the imaging platform 101 where the user is expected to be located. This allows the first camera 160 to capture the facial expressions of the user. Second camera 170 (not shown) is positioned below a second protruding element 182 of the at least one protruding element 180. Although the second protruding element 182 is shown positioned at right angle to protruding element 181, it can be pivoted around upright element 130 such that the second camera 170 (not shown) which is below the protruding element 182 is located substantially above the centre of the desktop base 110, such at its widest angle of view it captures the whole surface of the desktop base 110.

Referring to FIG. 2C, a top planar view of an imaging platform 102 in accordance with various embodiments is shown. As best seen in FIG. 2C, the first camera 160 is positioned on the at least one protruding element 180 such that it faces towards the front of the imaging platform 102, where the user is expected to be located. This allows the first camera 160 to capture the facial expressions of the user.

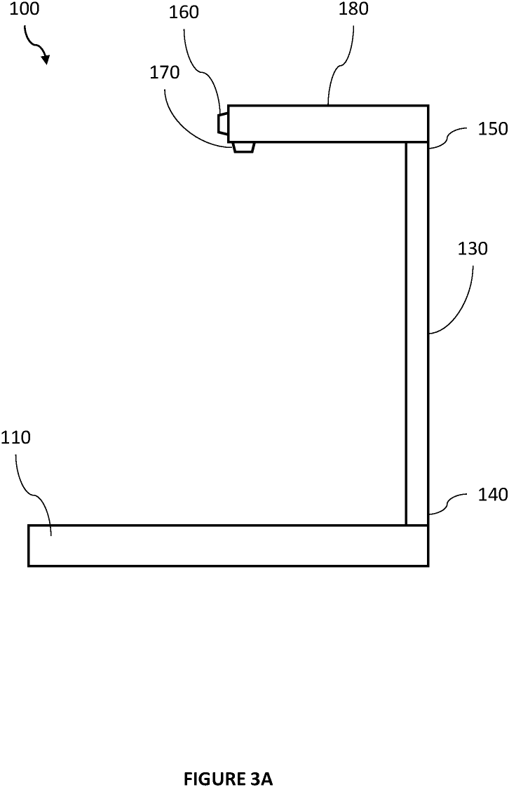

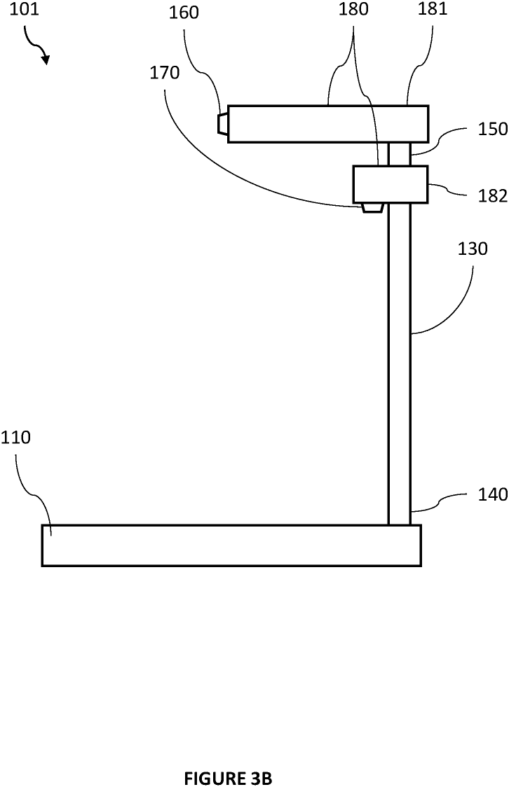

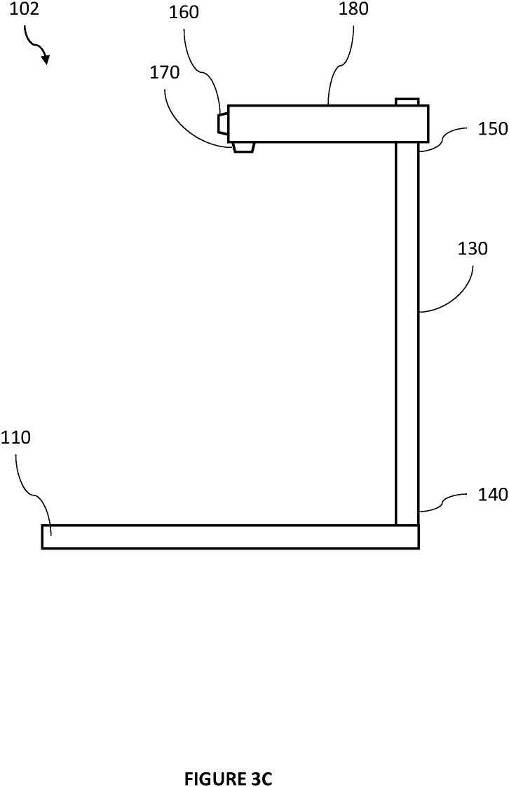

Referring to FIG. 3A, a right side planar view of an imaging platform 100 in accordance with various embodiments is shown. As seen in FIG. 3A, the first camera 160 is positioned on the at least one protruding element 180 such that it faces towards the front of the imaging platform 100, where the user is expected to be located. This allows the first camera 160 to capture the facial expressions of the user. The second camera 170 is positioned on the at least one protruding element 180 such that it faces the desktop base. The at least one protruding element 180 is coupled to the second end 150 of an upright element 130. In one example, the at least one protruding element 180 is movable along the upright element 130 in between the first end 140 and the second end 150.

Referring to FIG. 3B, a right side planar view of an imaging platform 101 in accordance with various embodiments is shown. As seen in FIG. 3B, the first camera 160 is positioned on a first protruding platform 181 of the at least one protruding element 180 such that it faces towards the front of the imaging platform 101, where the user is expected to be located. This allows the first camera 160 to capture the facial expressions of the user. The second camera 170 is positioned on a second protruding element 182 of the at least one protruding element 180 such that it faces the desktop base. The first protruding element 181 and second protruding element 182 of the at least one protruding element 180 are coupled to an upright element 130, preferably nearer to the second end 150. In one example, the at least one protruding element 180 is movable along the upright element 130 in between the first end 140 and the second end 150.

Referring to FIG. 3C, a right side planar view of an imaging platform 102 in accordance with various embodiments is shown. As seen in FIG. 3C, the first camera 160 is positioned on the at least one protruding element 180 such that it faces towards the front of the imaging platform 102, where the user is expected to be located. This allows the first camera 160 to capture the facial expressions of the user. The second camera 170 is positioned on the at least one protruding element 180 such that it faces the desktop base. The at least one protruding element 180 is coupled to the second end 150 of an upright element 130. In one example, the at least one protruding element 180 is movable along the upright element 130 in between the first end 140 and the second end 150.

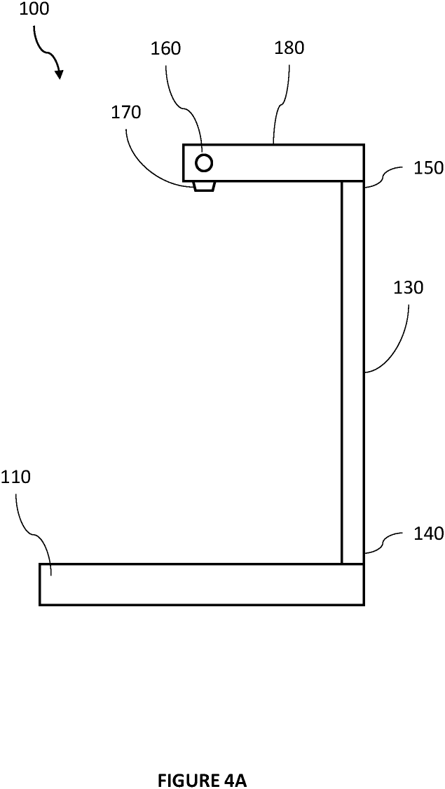

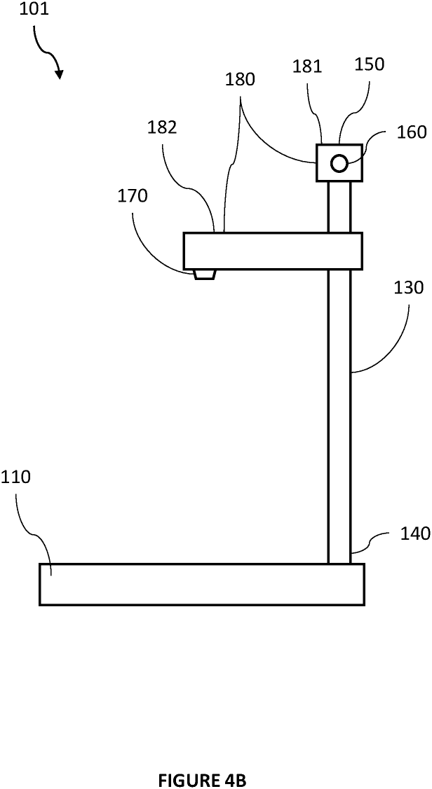

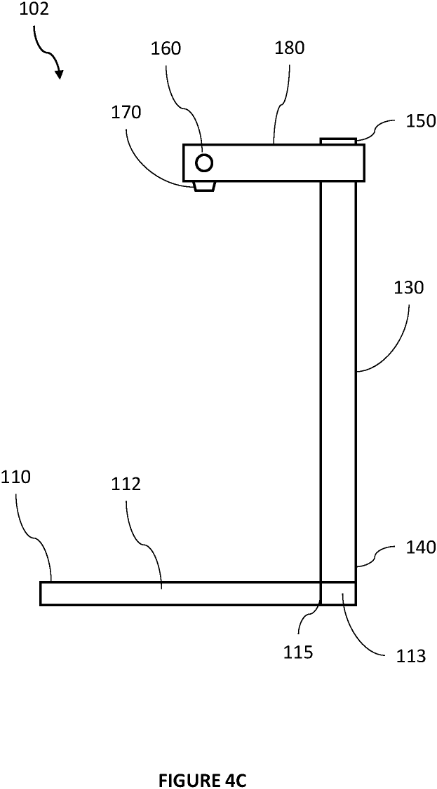

Referring to FIG. 4A, a front planar view of an imaging platform 100 in accordance with various embodiments is shown. The first camera 160 is positioned on the at least one protruding element 180 such that it faces towards the front of the imaging platform 100, where the user is expected to be located. This allows the first camera 160 to capture the facial expressions of the user. The second camera 170 is facing the desktop base 110 such that at its widest angle of view, it captures the whole surface of the desktop base 110. The second camera 170 can for example have an autofocus lens or a fixed focus lens, and/or a zoom lens (variable focal length) or a prime lens (fixed focal length). In one example, the at least one protruding element 180 is moved upwards (towards second end 150) or downwards (towards first end 140) along the upright element 130 and an autofocus lens on the second camera 170 is used advantageously to get the surface of the desktop base 110 and/or the objects on the desktop base 110 back in focus. In another example, objects of different heights are placed on the desktop base 110 and an autofocus lens on the second camera 170 is used advantageously to get the surface of the desktop base 110 and/or the desired portions of the objects on the desktop base 110 in focus. Advantageously, the range of movement of the at least one protruding element 180 can be limited to the depth of field of the second camera 170, in which case an autofocus lens may not be needed. Zoom lens can be used for the second camera 170 to provide a closer or wider look of the surface of the desktop base 110 and/or the objects on the desktop base 110. Digital zoom techniques (achieved by cropping) can also be used. Alternatively, or in combination, a closer or wider look of the surface of the desktop base 110, and/or the objects on the desktop base 110 can also be obtained by moving the at least one protruding element 180 upwards or downwards along the upright element 130, or having a telescopic upright element 130 which can extend and retract upwards and downwards.

Referring to FIG. 4B, a front planar view of an imaging platform 101 in accordance with various embodiments is shown. The first camera 160 is positioned on a first protruding element 181 of the at least one protruding element 180 such that it faces towards the front of the imaging platform 101, where the user is expected to be located. This allows the first camera 160 to capture the facial expressions of the user. The second camera 170 is positioned on a second protruding element 182 of the at least one protruding element 180, and is facing the desktop base 110 such at its widest angle of view, it captures the whole surface of the desktop base 110. The second camera 170 can for example have an autofocus lens or a fixed focus lens, and/or a zoom lens (variable focal length) or a prime lens (fixed focal length). In one example, the second protruding element 182 is moved upwards (towards second end 150) or downwards (towards first end 140) along the upright element 130 and an autofocus lens on the second camera 170 is used advantageously to get the surface of the desktop base 110 and/or the objects on the desktop base 110 back in focus. In another example, objects of different heights are placed on the desktop base 110 and an autofocus lens on the second camera 170 is used advantageously to get the surface of the desktop base 110 and/or the desired portions of the objects on the desktop base 110 in focus. Advantageously, the range of movement of the at least one protruding element 180 can be limited to the depth of field of the second camera 170, in which case an autofocus lens may not be needed. Zoom lens can be used for the second camera 170 to provide a closer or wider look of the surface of the desktop base 110 and/or the objects on the desktop base 110. Digital zoom techniques (achieved by cropping) can also be used. Alternatively, or in combination, a closer or wider look of the surface of the desktop base 110, and/or the objects on the desktop base 110 can also be obtained by moving the second protruding element 182 upwards or downwards along the upright element 130, or having a telescopic upright element 130 which can extend and retract upwards and downwards.

Referring to FIG. 4C, a front planar view of an imaging platform 102 in accordance with various embodiments is shown. The first camera 160 is positioned on the at least one protruding element 180 such that it faces towards the front of the imaging platform 102, where the user is expected to be located. This allows the first camera 160 to capture the facial expressions of the user. The second camera 170 is facing downwards, towards a horizontal plane bounded by the extensions (112, 113) of the desktop base 110, e.g., a supporting surface which the desktop base 110 is on. At its widest angle of view, the second camera 170 captures the surface of the supporting surface which the desktop base 110 is on as bounded by the extensions (112, 113) of the desktop base, with corner 115 indicating one extremity captured within the frame. The second camera 170 can for example have an autofocus lens or a fixed focus lens, and/or a zoom lens (variable focal length) or a prime lens (fixed focal length). In one example, the at least one protruding element 180 is moved upwards (towards second end 150) or downwards (towards first end 140) along the upright element 130 and an autofocus lens on the second camera 170 is used advantageously to get the surface of the supporting surface which the desktop base 110 is on and/or the objects on the supporting surface which the desktop base 110 is on back in focus. In another example, objects of different heights are placed on the supporting surface which the desktop base 110 is on, and an autofocus lens on the second camera 170 is used advantageously to get the supporting surface which the desktop base 110 is on, and/or the desired portions of the objects on the supporting surface which the desktop base 110 is on in focus. Advantageously, the range of movement of the at least one protruding element 180 can be limited to the depth of field of the second camera 170, in which case an autofocus lens may not be needed. Zoom lens can be used for the second camera 170 to provide a closer or wider look of the supporting surface which the desktop base 110 is on, and/or the objects on the supporting surface which the desktop base 110 is on. Digital zoom techniques (achieved by cropping) can also be used. Alternatively, or in combination, a closer or wider look of the supporting surface which the desktop base 110 is on, and/or the objects on the supporting surface which the desktop base 110 is on can also be obtained by moving the at least one protruding element 180 upwards or downwards along the upright element 130, or having a telescopic upright element 130 which can extend and retract upwards and downwards.

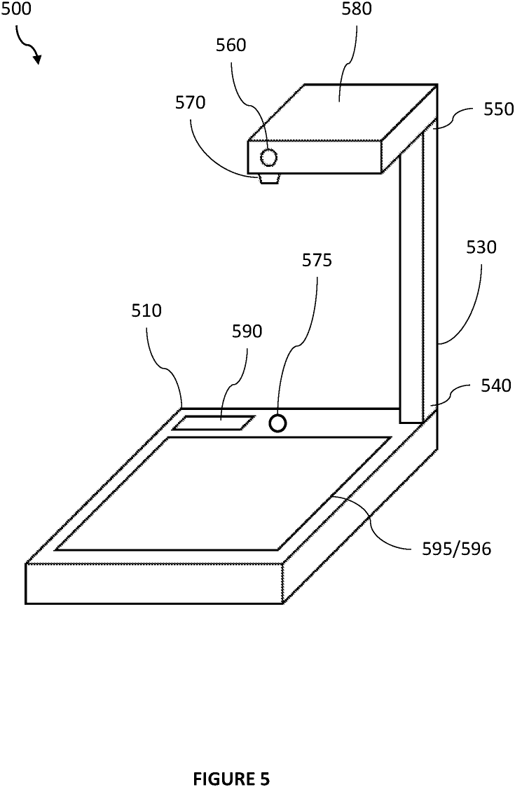

Referring to FIG. 5, a top front right perspective view of an imaging platform 500 in accordance with various embodiments is shown. In one embodiment, the imaging platform 500 has a horizontal desktop base 510 which lies flat on a supporting surface such as a table top (not shown). An upright element 530 having a first end 540 and a second end 550 is coupled to the desktop base 510 at the first end 540. The second end 550 of the upright element 530 is coupled to at least one protruding element 580 having a first camera 560 and a second camera 570 positioned thereon. The first camera 560 faces forward and may be pivotable around the horizontal axis, and/or the vertical axis. Pivoting the first camera 560 around the horizontal axis allows the first camera 560 to be tilted upwards or downwards, whereas pivoting around the vertical axis allows the first camera 560 to be turned to the left or right. The pivoting can be achieved by having the first camera 560 attached to a mechanical structure (e.g. ball-mount, swivel-mount, etc.) on the protruding element. Advantageously, pivoting the first camera 560 around the horizontal axis and/or the vertical axis allows the first camera 560 to be adjusted towards the user so that the facial expression of the user can be captured by the first camera 560. The horizontal and/or vertical pivoting can be by manual or motorized or automatic means. Although the upright element 530 is shown to be cuboid in shape, it can also be circular in shape. Advantageously, the at least one protruding element 580 can move about and /or pivot around the upright element 530 along its vertical axis. In a preferred embodiment, the at least one protruding element 580 is positioned near the second end 550 of the upright element 530, and the upright element 530 is of sufficient height such that the at least one protruding element 580 is at or near to the user’s eye-level when the imaging platform 500 is placed on a desk.

The second camera 570 faces the desktop base 510 such that at its widest angle of view, it captures the whole surface of the desktop base 510. The desktop base 510 may be rectangular shaped, orientated in portrait or landscape configuration. Advantageously, the desktop base is of the same shape and orientation as the image sensor (not shown) within the second camera 570 as it allows for more efficient use of the camera’s image sensor to capture presentation/teaching materials that may be in different formats and layouts (including square, and rectangular that may be landscape or portrait orientated). In one example, imaging platform 500 has a display 595 positioned on the surface of the desktop base 510. Some examples of display 595 are an LCD display, or an OLED display. In one further example, a digitizer 596 may be positioned on the desktop base 510, above the display 595. The digitizer 596 can be a layer of glass designed to convert analogue touches into digital signals. Advantageously, the digitizer 596 allows the user to write or draw directly on the display by converting the pressure from the finger(s) or stylus into a digitized signal and displaying the digitized signal or a form of the digitized signal on the display 595. The second camera 570 can for example have an autofocus lens or a fixed focus lens, and/or a zoom lens (variable focal length) or a prime lens (fixed focal length). In one example, the at least one protruding element 580 is moved upwards or downwards along the upright element 530 and an autofocus lens on the second camera 570 is used advantageously to get the surface of the desktop base 510, the display 595, and/or the objects on the desktop base 510 back in focus. In another example, objects of different heights are placed on the desktop base 510 and an autofocus lens on the second camera 570 is used advantageously to get the surface of the desktop base 510, the display 595 and/or the correct portions of the objects on the desktop base 510 in focus. Advantageously, the range of movement of the at least one protruding element 580 can be limited to the depth of field of the second camera 570, in which case an autofocus lens may not be needed. Zoom lens can be used for the second camera 570 to provide a closer or wider look at the surface of the desktop base 510 and/or the objects on the desktop base 510. Digital zoom techniques (achieved by cropping) can also be used. Alternatively, or in combination, a closer or wider look of the surface of the desktop base 510, the display 595, and/or the objects on the desktop base 510 can also be obtained by moving the at least one protruding element 580 upwards or downwards along the upright element 530, or having a telescopic upright element 530 which can extend and retract upwards and downwards. Advantageously, the second camera 570 can be used to capture a wide variety of objects and filling the screen with the scene/object of interest, from a watch maker working on a watch movement (small), to physically large documents like an artist’s artwork on larger canvases, and a chemistry teacher’s test tube experiments.

A third camera 575 is positioned on the desktop base 510. The third camera 575 may be advantageously located in a position at an upper portion of the desktop base 510 such that it is located at the other end of the desktop base 510, opposite to where the user is expected to be. The third camera 575 is substantially upward facing, angled towards the user’s head. This allows the third camera 575 to capture the facial expression of the user, especially while the user is looking down at the desktop base 510 or the display 595, or is writing/drawing on material that are on the desktop base 510 or on the digitizer 596.

A control panel 590 for selecting from a selection of a plurality of different outputs is included in the imaging platform 500. Although the control panel 590 is shown located at an upper portion of the desktop base 510, it can be located anywhere on the imaging platform that is easily accessible by the user, and preferably located such that the user is able to access it without obstructing the view of the first camera 560 and the second camera 570. For example, the control panel 590 can be located on the at least one protruding element 580. The control panel 590 can also be coupled to the imaging platform 500 via wired cable or wirelessly. The control panel 590 has a selection of a plurality of different outputs, which the user can select using, for example, buttons, switches, knobs and the like. In one example, the selection of a plurality of outputs of the control panel 590 can also be displayed on the display 595 and selection can be made via the digitizer 596. Some examples of the selection of the plurality of different outputs are shown in FIGS. 9A/9B/10.

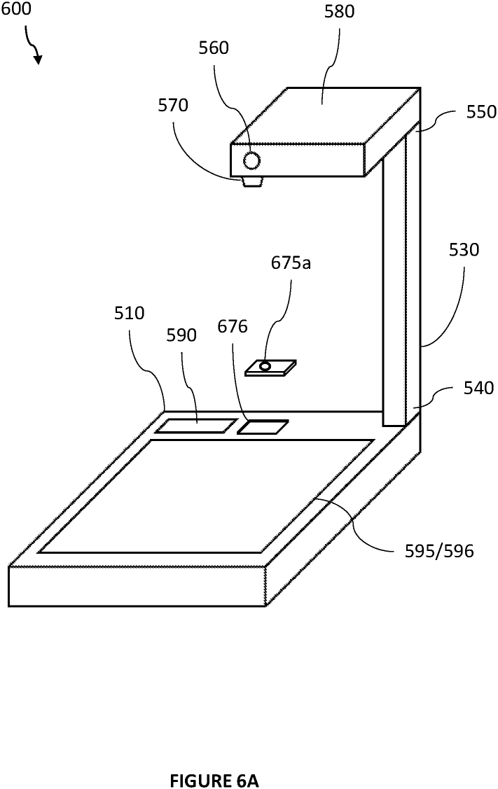

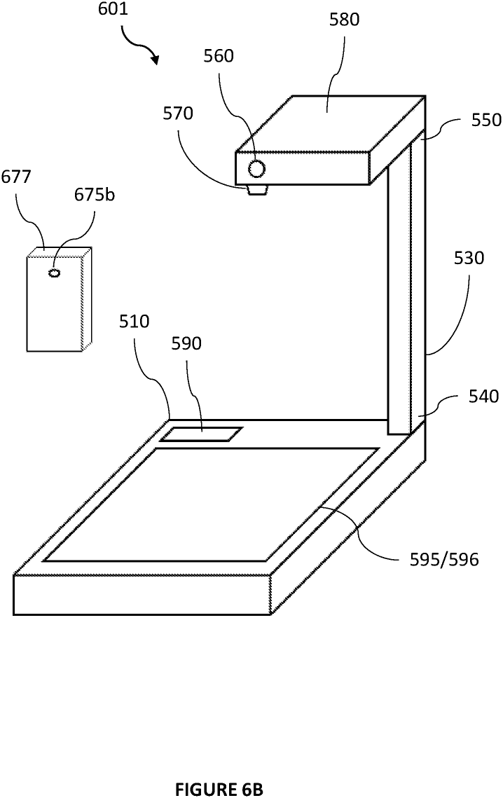

Referring to FIG. 6A, a top front right perspective view of an imaging platform 600 in accordance with various embodiments is shown. A third camera 675a is removably coupled to the desktop base 510. A charging dock 676 is positioned on the desktop base 510 to removably couple the third camera 675a, and to charge the third camera 675a while it is docked. Advantageously, the detachable third camera 675a can be positioned by the user in a location to capture the facial expression of the user, or at any other location to capture any object or scenery of interest within or about or away from the imaging platform 600. The third camera 675a can be wirelessly connected to the imaging platform 600. The wireless connection can be via wireless USB, wireless HDMI, Wi-Fi Direct or the like, or a proprietary wireless connection.

Referring to FIG. 6B, a top front right perspective view of an imaging platform 601 in accordance with various embodiments is shown. A third camera 675b is located on a mobile device 677 that is wirelessly connected to the desktop base 510. The wireless connection can be via wireless USB, wireless HDMI, Wi-Fi Direct or the like. Advantageously, the mobile device 677 with the third camera 675b can be positioned by the user in a location to capture the facial expression of the user, or at any other location to capture any object or scenery of interest within or about or away from the imaging platform 601.

As shown in FIGS. 5, 6A and 6B, a processor (not shown) obtains at least one camera output from the first camera 560, the second camera 570, and/or the third camera (575, 675a/b) based on the selection of the plurality of outputs on the control panel 590, and provides a processed output based on the selection of the plurality of outputs on the control panel 590. The processed output can be provided through an output port, such as but not limited to a USB port. The processed output can be a USB Video Device Class (UVC) stream.

A sensing means such as a sensor, a digitizer, and/or a combination of image analysis of the output from at least one of the first camera 560, second camera 570 or third camera (575, 675a/b) can be configured to allow the processor to detect the presence of activity on or near the desktop base 510. The sensing means can include proximity, ultrasonic, capacitive, photoelectric, inductive, or magnetic sensors, or image sensors and vision software. For added robustness, a combination of sensors could also be used. From the signals sent to the processor, the processor can identify when there is activity on or near to the desktop base. Advantageously, the processor can replace the at least one camera output from the first camera 560 with the camera output from the third camera (575, 675a/b) when the indication from the sensing means is received. In one example, when the user is looking down at the desktop base 510 while writing on the digitizer 596, replacing the output of the first camera 560 with the output of the third camera (575, 675a/b), that is positioned to allow the third camera (575, 675a/b) to capture the facial expression of the user, allows the facial expression of the user to be captured even while the user is looking down at the desktop base 510. Advantageously, the facial expression of the user and the presentation/teaching material can be captured and processed into a single output, enhancing both the experience of conducting and attending virtual meetings or lessons.

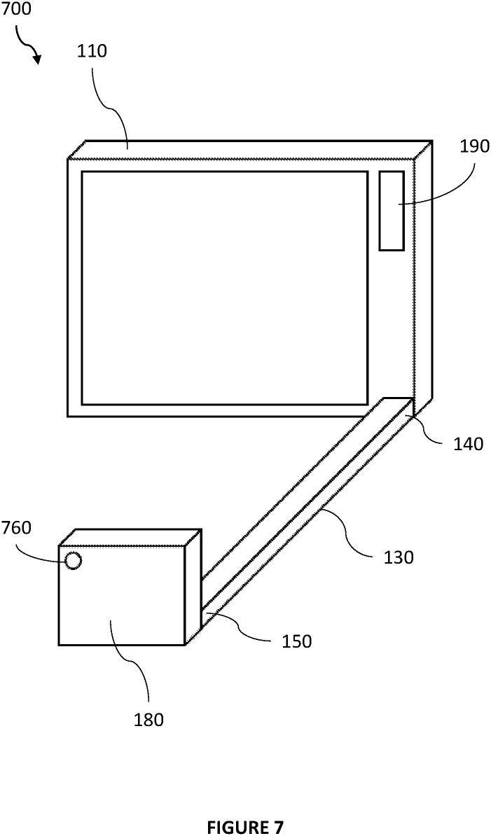

Referring to FIG. 7, a top back left perspective view rotated 90 degree clockwise of an imaging platform 700 in accordance with various embodiments is shown. As seen in FIG. 7, imaging platform 700 is rotated 90 degree clockwise to position the desktop base 110 from a horizontal orientation to a vertical orientation. The upright element 130 is horizontally orientated and lies on the supporting surface (e.g. table top), assisting in supporting the desktop base 110 in the vertical orientation. The upright element 130 has a first end 140 and a second end 150, the first end 140 is coupled to the desktop base 110, and the second end 150 is coupled to the at least one protruding element 180. Advantageously, a first camera 760 positioned on the at least one protruding element 180 can be pivoted/rotated horizontally to face the user that is expected to be positioned adjacent to the at least one protruding element 180, and facing both the at least one protruding element 180 and the desktop base 110. The second camera (not shown) faces the desktop base 110. When the desktop base 110 is in the vertical orientation, the imaging platform 700 can be used to capture and present the side view of object(s) that are in the area between the desktop base 110 and the protruding element 180 with the second camera (not shown), instead of the top view of the object(s) when the desktop base 110 is in the horizontal orientation. This is especially useful when the object(s) contains liquids, such as a test tube of liquid chemicals. Advantageously, the imaging platform 700 with the desktop base 110 in vertical orientation is able to capture and present the progress and outcome of a side view of an experiment being conducted using test tubes by using the second camera (not shown). For example, the experiment could involve pouring a chemical substance A from a test tube into another test tube with chemical substance B and observing the chemical reaction taking place in the test tube, the test tubes being positioned in the area between the desktop base 110 and the protruding element 180. At the same time, the facial expression of the user can be captured with the first camera 760 that has been pivoted/rotated to face the user, the user located in the area which the first camera 760 faces, and facing towards the first camera 760 such that the user has unhindered access to the area between the desktop base 110 and the protruding element 180 and is, for example, able to conduct the experiment earlier described with the test tubes. Advantageously, the facial expression of the user and the experiment progression can be captured and processed into a single output, enhancing both the experience of conducting and attending virtual meetings or lessons. A sensor (not shown) may be positioned within the imaging platform to detect the orientation of the desktop base, e.g., horizontal orientation or vertical orientation. The sensor can be a tilt sensor, an accelerometer, light sensor, magnetic sensor or a combination of multiple types and number of sensors. The detected orientation is sent to the processor, which processes the camera output from the first camera, second camera, and/or the third camera, and provides a processed output based on the detected orientation received. For example, if the sensor detects that the desktop base is in the vertical orientation, the output of the cameras can be suitably orientated by rotation. Similarly, the imaging platforms 500, 600 and 601 as shown in FIGS. 5, 6A and 6B can also be designed and positioned with the desktop base 510 in a vertical orientation and used as described.

Referring to FIG. 8, a front planar view of an imaging platform 700 in accordance with various embodiments is shown. As seen in FIG. 8, the second camera 770 faces the desktop base 110, and the first camera 760 faces a direction that is substantially opposite to the second camera 770 where the user of the imaging platform 700 is expected to be. When the desktop base is placed in this vertical orientation, the original right side of imaging platform 700 faces towards, and is supported by the supporting structure (tabletop / desktop). During use while in this orientation, the user is expected to be located at the original top end of the imaging platform, adjacent to and facing the at least one protruding element 180. Advantageously, having no obstructing structures, the original front and back of the imaging platform 700 provides an unhindered access for the user’s hands to objects placed in-between the desktop base 110 and the at least one protruding platform 180 of the imaging device 200. Similarly, the imaging platforms 500, 600 and 601 as shown in FIGS. 5, 6A and 6B can also be designed and positioned with the desktop base 510 in a vertical orientation and used as described.

Referring to FIG. 9A, a selection of a plurality of different outputs of an imaging platform (100, 101, 102, 200, 700) in accordance with various embodiments is shown. The numerals “1” and “2” in the figure represents the camera output from the first camera 160/760 and the second camera 170/770 respectively. The selection of the plurality of outputs can comprise of a single camera view of the first camera 910 or the second camera 915, a picture-in-picture view (920, 925), a side-by-side view (930, 935) or a custom view (not shown). As earlier described, a processor located within the imaging platform (100, 101, 102, 200, 700) obtains at least one camera output from the first camera 160/760 and/or the second camera 170/770 based on the selection of the plurality of outputs on the control panel 190 or the digitizer 196, and provides a processed output based on the selection of the plurality of outputs on the control panel 190 or the digitizer 196.

Referring to FIG. 9B, a selection of a plurality of different outputs of an imaging platform (100, 101, 102, 200, 700) in accordance with various embodiments is shown. The numerals “1” and “2” in the figure represents the camera output from the first camera 160/760 and the second camera 170/770 respectively. The selection of the plurality of outputs can comprise of a single camera view (940) of the first camera 160/760 or the second camera 170/770, a picture-in-picture view (950), a side-by-side view (960, 970) or a custom view (980). As earlier described, a processor located within the imaging platform (100, 101, 102, 200, 700) obtains at least one camera output from the first camera 160/760 and/or the second camera 170/770 based on the selection of the plurality of outputs on the control panel 190 or the digitizer 196, and provides a processed output based on the selection of the plurality of outputs on the control panel 190 or the digitizer 196.

When single camera view option (910, 915, 940) is selected, the processed output solely consists of the camera output of the first camera 160/760 or the second camera 170/770. As shown in FIG. 9A, each of the camera output can be assigned a selection option (910, 915), alternatively as shown in FIG. 9B, a toggle selection option 990 can be used to toggle between the camera output of the first camera 160/760 or the second camera 170/770 when single camera view selection option 940 is selected. In one example, the single camera view option (910, 915, 940) can also be configured to be the toggle selection option 990. By selecting single camera view option (910, 915, 940) again, the user can toggle between the camera output of the first camera 160/760 or the second camera 170/770.

When picture-in-picture view option (920, 925, 950) is selected, the processed output consists of the camera output of the first camera 160/760 and the second camera 170/770, with one output making up the full resolution (primary view) and the other output overlaid on the first output in an inset window (secondary view). As shown in FIG. 9A, each of the camera output making up the full resolution and the other in the inset window can be assigned a selection option (920, 925). In selection option 920, the camera output from the first camera 160/760 makes up the full resolution and the camera output from the second camera 170/770 is overlaid on top in an inset window 922, and in selection option 925, the camera output from the second camera 170/770 makes up the full resolution and the camera output from the first camera 160/760 is overlaid on top in an inset window 926. Alternatively, as shown in FIG. 9B, a toggle selection option 990 can be used to toggle between the camera output of the first camera 160/760 or the second camera 170/770 making up the full resolution, and the other in the inset window 952 when picture-in-picture view option 950 is selected. In one example, the picture-in-picture view option (920, 925, 950) can also be configured to be the toggle selection option 990. By selecting picture-in-picture view option (920, 925, 950) again, the user can toggle between the camera output of the first camera 160/760 or the second camera 170/770 making up the full resolution, and the other in the inset window 952. Although the inset windows (922, 926, 952) are shown to be at the bottom right position, the position can be located elsewhere (e.g., at the top left, top right or bottom left), and may be configured by the user. The size of the inset window may also be configured by the user. The user may configure the position and/or size of the inset window using an app which communicates with the imaging platform (100, 101, 102, 200, 700).

When side-by-side view option (930, 935, 960, 970) is selected, the processed output consists of the camera output of the first camera 160/760 and the second camera 170/770, in a left-right position (930, 960), or up-down position (935, 970). As shown in FIG. 9A and FIG. 9B, selection option 930 and 960 can be assigned to the camera outputs of first camera 160/760 and second camera 170/770 taking up the left and right position respectively, and selection options 935 and 970 can be assigned to the camera outputs of first camera 160/760 and second camera 170/770 taking up the upper and lower positions respectively. The camera outputs of first camera 160/760 and second camera 170/770 can also be configured by the user to take up the right and left position or lower and upper positions respectively, using an app which communicates with the imaging platform (100, 101, 102, 200, 700). FIG. 9B shows a toggle selection option 990 which can be used to toggle between the camera output of the first camera 160/760 or the second camera 170/770 taking up the left and/or up position. In one example, the side-by-side view option (930, 935, 960, 970) can also be configured to be the toggle selection option 990. By selecting side-by-side view option (930, 935, 960, 970) again, the user can toggle between the camera outputs of the first camera 160/760 or the second camera 170/770 taking up the left and/or up position.

When custom view option (980) is selected, the processed output consists of the camera output of the first camera 160/760 and/or the second camera 170/770, taking up different portions and/or positions in the processed output. As shown in FIG. 9B, the camera output of the first camera 160/760 makes up the full resolution, and the camera output of the second camera 170/770 is overlaid on the first output in an inset window at the bottom left position. The size of the inset window and/or position can be configured by the user using an app which communicates with the imaging platform (100, 101, 102, 200, 700). The toggle selection option 990 can be used to toggle between the camera outputs of the first camera 160/760 or the second camera 170/770 taking up the various positions defined by the user. In one example, the custom view option (980) can also be configured to be the toggle selection option 990. By selecting custom view option (980) again, the user can toggle between the camera outputs of the first camera 160/760 or the second camera 170/770.

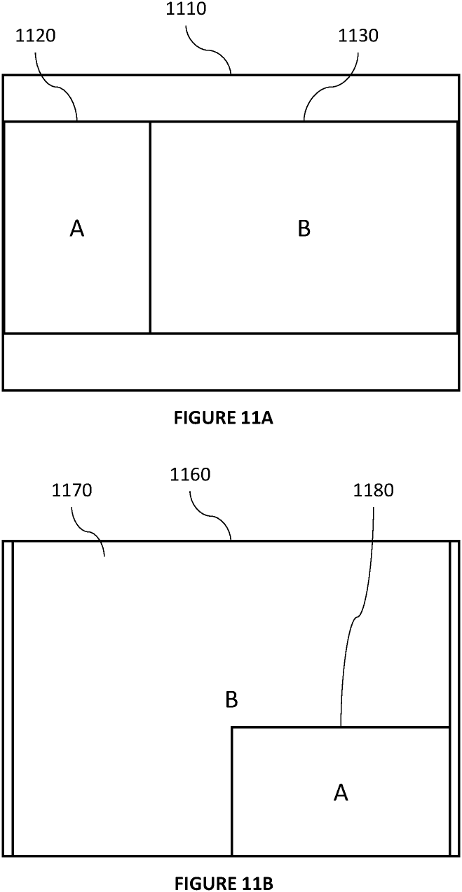

Although the outputs of the first camera 160/760 and the second camera 170/770 are shown to be taking up a certain proportion of the processed output, this proportion may be different by default and/or assigned differently by the user. A further example will be shown in FIGS. 11A/B.

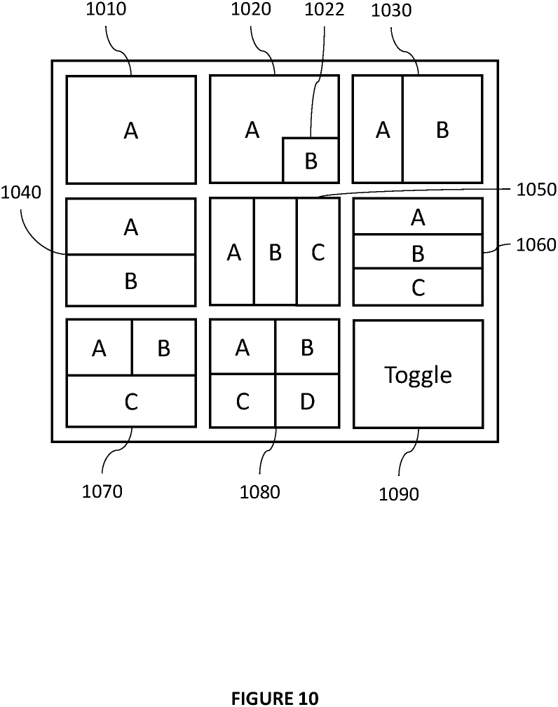

Referring to FIG. 10, a selection of a plurality of different outputs of an imaging platform 500/600/601 in accordance with various embodiments is shown. The alphabets “A”, “B”, “C” and “D” in the figure represents different camera outputs that can be from the first camera 560, the second camera 570, the third camera 575/675a/675b and/or an external camera connected via wire or wirelessly to the imaging platform. The selection of the plurality of outputs can comprise of a single camera view 1010, a picture-in-picture view 1020, a side-by-side view 1030/1040/1050/1060 or a custom view 1070/1080. As earlier described, a processor (not shown) located within the imaging platform 500/600/601 obtains at least one camera output from the first camera 560, the second camera 570 and/or the third camera 575/675a/675b or the external camera connected via wire or wirelessly to the imaging platform based on the selection of the plurality of outputs on the control panel 590 or the digitizer 596, and provides a processed output based on the selection of the plurality of outputs on the control panel 590 or the digitizer 596.

When single camera view option 1010 is selected, the processed output solely consists of the camera output of a single camera (one of the first camera 560, the second camera 570, the third camera 575/675a/675b, or the external camera connected via wire or wirelessly to the imaging platform). A toggle selection option 1090 can be used to toggle between the camera output of the first camera 560, the second camera 570, the third camera 575/675a/675b or the external camera connected via wire or wirelessly to the imaging platform. In one example, the single camera view option 1010 can also be configured to be the toggle selection option 1090. By selecting single camera view option 1010 again, the user can toggle between the camera output of the first camera 560, the second camera 570, the third camera 575/675a/675b or the external camera connected via wire or wirelessly to the imaging platform.

When picture-in-picture view option 1020 is selected, the processed output consists of the camera output of at least two cameras, with one output making up the full resolution and the other output(s) each overlaid on the first output in an inset window. In one example, the camera outputs “A” and “B” are from the first camera 560 and the second camera 570, or the third camera 575/675a/675b and the second camera 570 with one output “A” making up the full resolution and the other output “B” overlaid on the first output in an inset window 1022. A toggle selection option 1090 can be used to toggle among the camera outputs of the first camera 560, the second camera 570, the third camera 575/675a/675b or the external camera connected via wire or wireless to the imaging platform making up the full resolution, and also to toggle between the camera output of the remaining camera output(s) in the inset window(s) 1022. Although only one inset window 1022 is shown, a person skilled in the art can also add additional inset window for each of the remaining camera outputs as required. In one example, the picture-in-picture view option 1020 can also be configured to be the toggle selection option 1090. By selecting picture-in-picture view option 1020 again, the user can toggle among the camera outputs of the first camera 560, the second camera 570, the third camera 575/675a/675b or the external camera connected via wire or wireless to the imaging platform making up the full resolution, and also to toggle between the camera output of the remaining camera output(s) in the inset window(s) 1022.

When side-by-side view option (1030, 1040, 1050, 1060) is selected, the processed output consists of the camera outputs of at least two cameras, in a left-right position (1030, 1050) or a up-down position (1040, 1060). In one example 1030, the camera outputs “A” and “B” are from the first camera 560 and the second camera 570, or the third camera 575/675a/675b and the second camera 570 with one output “A” on the left side and the other output “B” on the right side. In another example 1050, the camera outputs “A”, “B” and “C” are from the first camera 560, the second camera 570, and the third camera 575/675a/675b with one output “A” on the left side, one output “B” in the middle, and the other output “C” on the right side. In one example 1040, the camera outputs “A” and “B” are from the first camera 560 and the second camera 570, or the third camera 575/675a/675b and the second camera 570 with one output “A” in the upper position and the other output “B” in the lower position. In another example 1060, the camera outputs “A”, “B” and “C” are from the first camera 560, the second camera 570, and the third camera 575/675a/675b with one output “A” in the top most position, one output “B” in the middle, and the other output “C” in the bottom position. A toggle selection option 1090 can be used to toggle among the camera outputs of the first camera 560, the second camera 570, the third camera 575/675a/675b or the external camera connected via wire or wireless taking up the left and/or top most position. In one example, the side-by-side view option (1030, 1040, 1050, 1060) can also be configured to be the toggle selection option 1090. By selecting side-by-side view option (1030, 1040, 1050, 1060) again, the user can toggle among the camera outputs of the first camera 560, the second camera 570, the third camera 575/675a/675b or the external camera connected via wire or wireless taking up the left and/or top most position.

When custom view option 1070/1080 is selected, the processed output can consist of the camera output of at least one of the first camera 560, the second camera 570, the third camera 575/675a/675b, and/or the external camera connected via wire or wirelessly to the imaging platform 500/600/601 taking up different portions and/or positions in the processed output. The portion and/or positions can be pre-defined by the user using an app which communicates with the imaging platform 500/600/601. In one example 1070, the camera outputs “A”, “B” and “C” are from the first camera 560, the second camera 570, and the third camera 575/675a/675b with output “A” in the upper left position, output “B” in the upper right position, and output “C” at the bottom position. In another example 1080, the camera outputs “A”, “B”, “C” and “D” are from the first camera 560, the second camera 570, the third camera 575/675a/675b and the external camera, with output “A” in the upper left position, output “B” in the upper right position, output “C” in the bottom left position and output “D” in the bottom right position. A toggle selection option 1090 can be used to toggle among the camera outputs of the first camera 560, the second camera 570, the third camera 575/675a/675b or the external camera taking up the various portions/positions defined by the user. In one example, the custom view option 1070/1080 can also be configured to be the toggle selection option 1090. By selecting custom view option 1070/1080 again, the user can toggle among the camera outputs of the first camera 560, the second camera 570, the third camera 575/675a/675b or the external camera taking up the various portions/positions defined by the user.

Although the camera outputs “A”, “B”, “C” and “D” are shown to be taking up a certain proportion of the processed output, this proportion may be different by default and/or assigned differently by the user. A further example will be shown in FIGS. 11A/B.

Referring to FIG. 11A, an output of an imaging platform 100/101/102/200/500/600/601/700 in accordance with various embodiments is shown. This output 1110 would have been selected from the selection of a plurality of different outputs, as shown in FIG. 9A, FIG. 9B and FIG. 10 selections 930, 960 and 1030 respectively. For example, the camera outputs “A” and “B” can be from the first camera 160/560/760 and the second camera 170/570/770. Camera output “A” can show the face of the user in portrait mode in the left window 1120, while camera output “B” can show the presentation / teaching materials in landscape mode in the right window 1130. This layout optimizes the area of the display, making it possible to provide both the facial expression of the user and the presentation / teaching materials in a single output that is able to enhance the user’s experience of conducting virtual meetings or lessons, as well as enhancing the viewer’s experience of attending the virtual meetings or lessons.

Referring to FIG. 11B, an output of an imaging platform 100/101/102/200/500/600/601/700 in accordance with various embodiments is shown. This output 1160 would have been selected from the selection of a plurality of different outputs, as shown in FIG. 9A, FIG. 9B and FIG. 10 selections 925, 950 and 1020 respectively. For example, the camera outputs “A” and “B” can be from the first camera 160/560/760 and the second camera 170/570/770. Camera output “A” can show the face of the user in portrait mode in the bottom-right window 1180, while camera output “B” can show the presentation / teaching materials in portrait mode in the main window 1170. This layout optimizes the area of the display, making it possible to provide both facial expression of the user as well as presentation / teaching materials in a single output that is able to enhance the user’s experience of conducting virtual meetings or lessons, as well as enhancing the viewer’s experience of attending the virtual meetings or lessons.

Thus, it can be seen that a multiview camera platform for capturing and providing both facial expression and written content in a single view has been provided. An advantage of the present invention is that it is able to enhance the user’s experience of conducting virtual meetings or lessons.

While exemplary embodiments have been presented in the foregoing detailed description of the present embodiments, it should be appreciated that a vast number of variations exists. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims. For example, the design of the base for imaging platform 102 can be used for imaging platforms 100 and 101, and the design of the at least one protruding platform 180 for imaging platform 101 can be used for imaging platforms 100 and 102. Additional input port(s) can also be located on the imaging platform for additional auxiliary camera input(s). The additional camera input(s) can be received by the processor, available for selection within the selection of a plurality of different outputs, and included in the processed output.

### EXAMPLES

The following numbered examples are embodiments.

1. An imaging platform for capturing multiple views comprising:
a desktop base;
an upright element having a first end and a second end, the first end coupled to the desktop base;
a first camera and a second camera positioned on at least one protruding element coupled to the upright element, the second camera facing the desktop base;
a control panel for selecting a selection of a plurality of different outputs; and
a processor,
wherein the processor obtains at least one camera output from the first camera and/or the second camera based on the selection of the plurality of outputs on the control panel, and provides a processed output based on the selection of the plurality of outputs on the control panel.

2. The imaging platform of example 1, wherein the first camera is positioned on a first protruding element of the at least one protruding element, and the second camera is positioned on a second protruding element of the at least one protruding element.

3. The imaging platform of example 1, wherein the second camera comprises an image sensor, and wherein the desktop base is of the same shape and orientation as the image sensor.

4. The imaging platform of any of examples 1 to 3, further comprising:
a display positioned on the desktop base.

5. The imaging platform of example 4, further comprising:
a digitizer positioned on the desktop base, above the display.

6. The imaging platform of any of examples 1 to 5, further comprising:
a third camera positioned on the desktop base,
wherein the third camera is facing upwards in a direction away from the desktop base.

7. The imaging platform of examples 6, further comprising:
a sensing means for sending an indication to the processor when there is activity on the desktop base,
wherein the processor replaces the at least one camera output from the first camera with a camera output from the third camera when the indication from the sensing means is received.

8. The imaging platform of examples 1-7, wherein the at least one protruding element is movable along the upright element in a range of movement that is between the first end and the second end of the upright element.

9. The imaging platform of example 8, wherein the second camera has a depth of field, and wherein the range of movement of the at least one protruding element is limited to the depth of field of the second camera.

10. The imaging platform of example 1, wherein the desktop base can be positioned in a horizontal orientation or a vertical orientation, and wherein the first camera is pivotable to face a direction opposite to the second camera.

11. The imaging platform of example 10, further comprising:
at least one sensor to detect an orientation of the desktop base,
wherein the processor received the orientation detected by the at least one sensor, and provides a processed output based on the orientation detected.

12. The imaging platform of examples 1-11, further comprising:
a connection means for connecting an external device with a camera to the imaging platform,
wherein the processor further obtains a camera output from the external device based on the selection of the plurality of outputs on the control panel in providing the processed output.

13. The imaging platform of example 12, wherein the connection means is wired and/or wireless.

14. The imaging platform of examples 1-13, wherein the processed output is provided through an output port.

15. The imaging platform of example 14, wherein the output port is a USB port, and the processed output is a USB Video Device Class (UVC) stream.

What is claimed is:

1. An imaging platform for capturing multiple views comprising:
a desktop base;
an upright element having a first end and a second end, the first end coupled to the desktop base;
a first camera and a second camera positioned on at least one protruding element coupled to the upright element, the second camera facing the desktop base;
a control panel for selecting a selection of a plurality of different outputs; and
a processor,
wherein the processor obtains at least one camera output from the first camera and/or the second camera based on the selection of the plurality of outputs on the control panel, and provides a processed output based on the selection of the plurality of outputs on the control panel.

2. The imaging platform of claim 1, wherein the first camera is positioned on a first protruding element of the at least one protruding element, and the second camera is positioned on a second protruding element of the at least one protruding element.

3. The imaging platform of claim 1, wherein the second camera comprises an image sensor, and wherein the desktop base is of the same shape and orientation as the image sensor.

4. The imaging platform of claim 1, further comprising:
a display positioned on the desktop base.

5. The imaging platform of claim 4, further comprising:
a digitizer positioned on the desktop base, above the display.

6. The imaging platform of claim 1, further comprising:
a third camera positioned on the desktop base,
wherein the third camera is facing upwards in a direction away from the desktop base.

7. The imaging platform of claim 6, further comprising:
a sensing means for sending an indication to the processor when there is activity on the desktop base,
wherein the processor replaces the at least one camera output from the first camera with a camera output from the third camera when the indication from the sensing means is received.

8. The imaging platform of claim 1, wherein the at least one protruding element is movable along the upright element in a range of movement that is between the first end and the second end of the upright element.

9. The imaging platform of claim 8, wherein the second camera has a depth of field, and wherein the range of movement of the at least one protruding element is limited to the depth of field of the second camera.

10. The imaging platform of claim 1, wherein the desktop base can be positioned in a horizontal orientation or a vertical orientation, and wherein the first camera is pivotable to face a direction opposite to the second camera.

11. The imaging platform of claim 10, further comprising:
at least one sensor to detect an orientation of the desktop base,
wherein the processor received the orientation detected by the at least one sensor, and provides a processed output based on the orientation detected.

12. The imaging platform of claim 1, further comprising:
a connection means for connecting an external device with a camera to the imaging platform,
wherein the processor further obtains a camera output from the external device based on the selection of the plurality of outputs on the control panel in providing the processed output.

13. The imaging platform of claim 12, wherein the connection means is wired and/or wireless.

14. The imaging platform of claim 1, wherein the processed output is provided through an output port.

15. The imaging platform of claim 14, wherein the output port is a USB port, and the processed output is a USB Video Device Class (UVC) stream.

16. The imaging platform of claim 1, wherein the control panel is coupled to the imaging platform via wired cable or wirelessly.
